(19) United States
(12) Patent Application Publication
(10) Pub. No.: US 2026/0297911 A1
(43) Pub. Date: Oct. 1, 2026

(54) AUTOMATED TOILET SENSOR WITH FLOW-BASED SHUTOFF, LEAK DETECTION, AND ENERGY HARVESTING

(71) Applicant: Saya Life, Inc., Los Angeles, CA (US)

(72) Inventors: Sanjay Poojary, Irvine, CA (US); Chongliang Li, Irvine, CA (US)

(21) Appl. No.: 19/631,816

(22) Filed: Mar. 27, 2026

Related U.S. Application Data
(60) Provisional application No. 63/779,094, filed on Mar. 27, 2025.

(51) Int. Cl. E03B 7/07; E03B 7/00; E03D 9/00; G05D 7/06

(52) U.S. Cl. CPC E03B 7/071; E03B 7/003; E03B 7/078; E03D 9/00; G05D 7/0635

(57) ABSTRACT

A self-powered toilet monitoring system for preventing water waste in a water supply line fluidly coupled to a toilet. The system includes water sensors disposed on the water supply line for measuring one or more properties of a water flow. The system further includes a motorized shutoff valve for stopping the water flow. The system further includes a microcontroller coupled to the water sensors and the shutoff valve for analyzing the properties to detect anomalies and stop the water flow in response to the anomalies. The system further includes an energy harvesting module disposed on the water supply line configured to generate power from the water flow such that the system is powered by the energy harvesting module.

### CROSS-REFERENCE TO RELATED APPLICATIONS

This application is a non-provisional and claims benefit of U.S. Provisional Application No. 63/779,094 filed Mar. 27, 2025, the specification of which is incorporated herein in its entirety by reference.

### FIELD OF THE INVENTION

The present invention is directed to the field of water conservation and plumbing systems, specifically to devices that monitor water flow and pressure in toilets, detect anomalies such as leaks or continuously running toilets, and autonomously shut off water supply to prevent wastage. Additionally, the present invention is directed to energy harvesting from water flow to enable standalone, battery-free operation.

### BACKGROUND OF THE INVENTION

Conventional toilet systems often suffer from inefficiencies due to undetected leaks or continuously running toilets caused by faulty components such as flappers or fill valves. These issues lead to excessive water wastage, higher utility bills, and environmental harm. Existing solutions for leak detection or shutoff valves typically rely on external power sources or batteries, which add maintenance requirements and limit adoption. Thus, there exists a present need for a smart, self-sustaining toilet sensor system using advanced algorithms to analyze water flow rate and pressure, identify abnormal patterns associated with running toilets or leaks, and automatically shut off the water supply. Furthermore, there exists a present need for a system implementing water flow to harvest energy, ensuring uninterrupted operation without requiring external power sources.

### BRIEF SUMMARY OF THE INVENTION

It is an objective of the present invention to provide systems that allow for a smart, self-sustaining toilet sensor system using advanced algorithms to analyze water flow rate and pressure, identify abnormal patterns associated with running toilets or leaks, and automatically shut off the water supply, implementing water flow to harvest energy, ensuring uninterrupted operation without requiring external power sources, as specified in the independent claims. Embodiments of the invention are given in the dependent claims. Embodiments of the present invention can be freely combined with each other if they are not mutually exclusive.

The present invention features a self-powered toilet monitoring system for preventing water waste in a water supply line fluidly coupled to a toilet. The system may comprise one or more water sensors disposed on the water supply line, configured to measure one or more properties of a water flow. The system may further comprise a motorized shutoff valve disposed on the water supply line, configured to stop the water flow upon actuation. The system may further comprise a microcontroller communicatively coupled to the one or more water sensors and the motorized shutoff valve, configured to analyze the one or more properties to detect anomalies and actuate the motorized shutoff valve to stop the water flow in response to the anomalies. The system may further comprise an energy harvesting module disposed on the water supply line, operatively coupled to the one or more water sensors, the motorized shutoff valve, the microcontroller, or a combination thereof, configured to generate power from the water flow such that the one or more water sensors, the motorized shutoff valve, the microcontroller, or the combination thereof are powered by the energy harvesting module.

The present invention features a sensor system. The sensor system may comprise a flow meter and pressure sensor integrated into the water supply line to continuously monitor flow rate and pressure characteristics. The present invention features a processor configured to analyze flow and pressure data in real-time, employing machine learning algorithms or predefined heuristics to detect abnormal patterns such as leaks or continuously running toilets. The present invention features a motorized valve that activates to shut off the water supply when anomalies are detected, preventing further wastage. The present invention features a micro-turbine or piezoelectric system that captures energy from the flowing water to power the sensor, processor, and shutoff mechanism, eliminating the need for batteries or external power sources. The present invention features wireless connectivity features (e.g., Wi-Fi, Bluetooth®, Lorawan, Zwave®, or Zigbee®) to send alerts to users via a mobile application, enabling remote monitoring and control.

One of the unique and inventive technical features of the present invention is the implementation of an energy harvesting component in a toilet anomaly detection system. Without wishing to limit the invention to any theory or mechanism, it is believed that the technical feature of the present invention advantageously provides for the efficient detection of anomalies in flow and pressure in a toilet water line without the need for external power sources. None of the presently known prior references or works have the unique inventive technical feature of the present invention.

Furthermore, the inventive technical feature of the presently claimed invention is counterintuitive. The reason that it is counterintuitive is because it contributed to a surprising result. One of ordinary skill in the art would expect that due to the comparatively infrequent water flow in a toilet water line when compared to other types of water lines under more constant use, a toilet water line would be unsuitable for supporting an energy harvesting component. Surprisingly, the presently claimed invention is able to implement an energy harvesting device capable of powering a set of sensors and a microprocessor through the use of only the flow of water in a toilet water line. Thus, the inventive technical feature of the presently claimed invention contributed to a surprising result.

Another one of the unique and inventive technical features of the present invention is the implementation of a machine learning algorithm on a microprocessor to identify anomalies in the water flow of a toilet. Without wishing to limit the invention to any theory or mechanism, it is believed that the technical feature of the present invention advantageously provides for the autonomous, efficient, and accurate determination of anomalies in a toilet system contributing to water waste. None of the presently known prior references or works have the unique inventive technical feature of the present invention.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE SEVERAL VIEWS OF THE DRAWINGS

The features and advantages of the present invention will become apparent from a consideration of the following detailed description presented in connection with the accompanying drawings in which:

FIG. 1 shows a first embodiment of the self-powered toilet monitoring system of the present invention.

FIG. 2 shows a second embodiment of the self-powered toilet monitoring system of the present invention.

FIG. 3 shows a third embodiment of the self-powered toilet monitoring system of the present invention.

FIG. 4 shows a fourth embodiment of the self-powered toilet monitoring system of the present invention.

### DETAILED DESCRIPTION OF THE INVENTION

Following is a list of elements corresponding to a particular element referred to herein:
system 100
sensor devices 110
flow meter 111
pressure sensor 112
motorized shutoff valve 120
computing system/microcontroller 130
processor 131
memory component 132
energy harvesting module 140
wireless communication interface 150
water supply line 1000
toilet 2000

The term “water waste” is defined herein as the loss of water in an appliance due to leaks in the water supply line, malfunctions in components of the toilet, or a combination thereof.

The term “continuous flow” is defined herein as a flow of water that continues for an extended period of time abnormal for a toilet water supply line, indicative of a leak in the water supply line connected to the toilet.

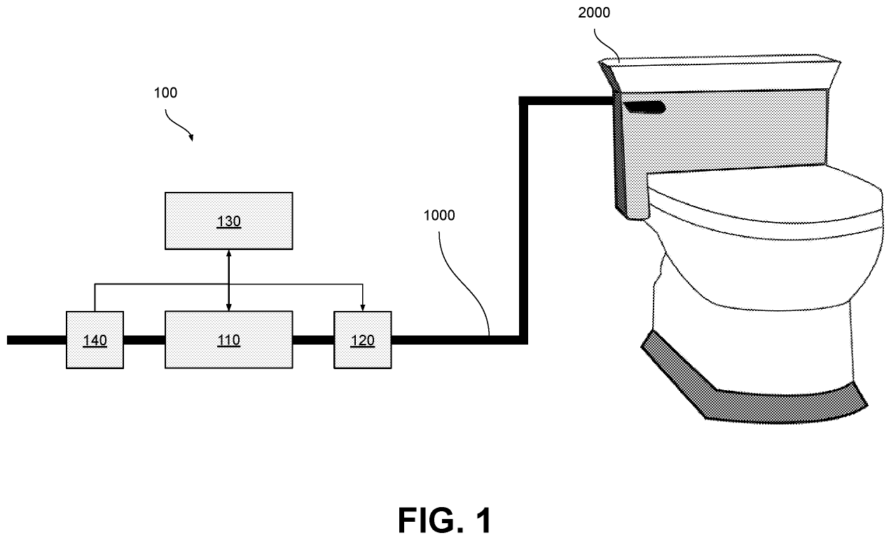

Referring now to FIG. 1, the present invention features a self-powered toilet monitoring system (100) for preventing water waste in a water supply line (1000) fluidly coupled to a toilet (2000). In some embodiments, the self-powered toilet monitoring system (100) may comprise one or more water sensors (110) disposed on the water supply line (1000), configured to measure one or more properties of a water flow. The system (100) may further comprise a motorized shutoff valve (120) disposed on the water supply line (1000), configured to stop the water flow upon actuation. The self-powered toilet monitoring system (100) may further comprise a microcontroller (130) communicatively coupled to the one or more water sensors (110) and the motorized shutoff valve (120), configured to analyze the one or more properties to detect anomalies and actuate the motorized shutoff valve (120) to stop the water flow in response to the anomalies. The self-powered toilet monitoring system (100) may further comprise an energy harvesting module (140) disposed on the water supply line (1000), operatively coupled to the one or more water sensors (110), the motorized shutoff valve (120), the microcontroller (130), or a combination thereof, configured to generate power from the water flow such that the one or more water sensors (110), the motorized shutoff valve (120), the microcontroller (130), or the combination thereof are powered by the energy harvesting module (140).

In some embodiments, the one or more water sensors may comprise a flow meter (111), a pressure sensor (112), or a combination thereof. In some embodiments, the anomalies may comprise properties indicative of continuous flow in the toilet (2000) caused by faulty fill valves, flappers, or a combination thereof, undetected leaks in a tank of the toilet (2000), the water supply line (1000), or a combination thereof, or a combination thereof. In some embodiments, the energy harvesting module (140) may comprise a micro-turbine placed inline with the water flow, a piezoelectric system capturing energy from fluctuations in pressure in the water flow, or a combination thereof. In some embodiments, the microcontroller (130) may be further configured to execute one or more machine learning algorithms configured to adaptively refine detection thresholds based on historical usage patterns. In some embodiments, the self-powered toilet monitoring system (100) may further comprise a wireless communication interface (150) communicatively coupled to the microcontroller (130), configured to send alerts and allow remote user interaction. In some embodiments, the remote user interaction of the wireless communication interface (150) may comprise remote configuration of detection parameters and manual shutoff control.

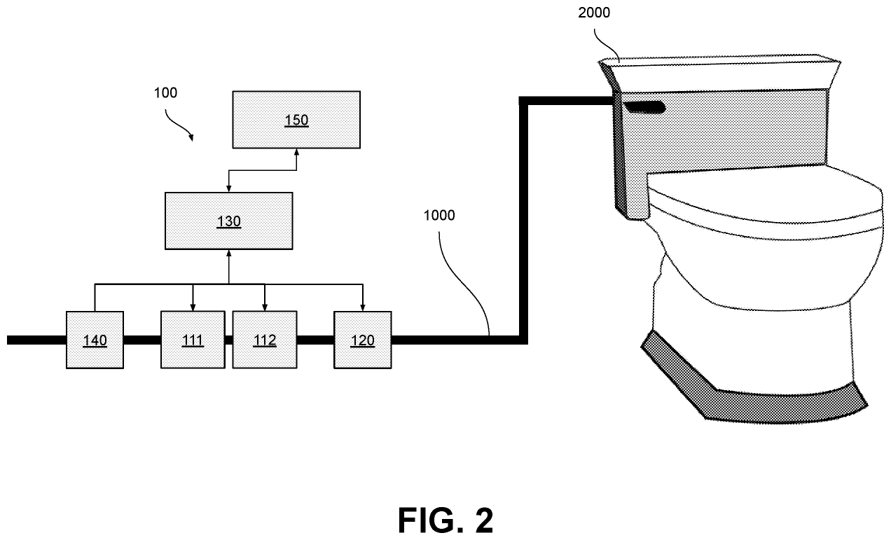

Referring now to FIG. 2, the present invention features a self-powered toilet monitoring system (100) for preventing water waste in a water supply line (1000) fluidly coupled to a toilet (2000). The self-powered toilet monitoring system (100) may comprise a flow meter (111) disposed on the water supply line (1000), configured to measure a flow rate of a water flow. The self-powered toilet monitoring system (100) may further comprise a pressure sensor (112) disposed on the water supply line (1000), configured to measure a pressure measurement of the water flow. The self-powered toilet monitoring system (100) may further comprise a motorized shutoff valve (120) disposed on the water supply line (1000), configured to stop the water flow upon actuation. The self-powered toilet monitoring system (100) may further comprise a microcontroller (130) communicatively coupled to the flow meter (111), the pressure sensor (112), and the motorized shutoff valve (120), configured to analyze the flow rate from the flow meter (111) and the pressure measurement from the pressure sensor (112) to detect anomalies and actuate the motorized shutoff valve (120) to stop the water flow in response to the anomalies.

The self-powered toilet monitoring system (100) may further comprise an energy harvesting module (140) disposed on the water supply line (1000), operatively coupled to the flow meter (111), the pressure sensor (112), the motorized shutoff valve (120), the microcontroller (130), or a combination thereof, configured to generate power from the water flow such that the flow meter (111), the pressure sensor (112), the motorized shutoff valve (120), the microcontroller (130), or the combination thereof are powered by the energy harvesting module (140). The self-powered toilet monitoring system (100) may further comprise a wireless communication interface (150) communicatively coupled to the microcontroller (130), configured to send alerts and allow remote user interaction.

In some embodiments, the anomalies may comprise properties indicative of continuous flow of the toilet (2000) caused by faulty fill valves, flappers, or a combination thereof, undetected leaks in a tank of the toilet (2000), the water supply line (1000), or a combination thereof, or a combination thereof. In some embodiments, the energy harvesting module (140) may comprise a micro-turbine placed inline with the water flow, a piezoelectric system capturing energy from fluctuations in pressure in the water flow, or a combination thereof. In some embodiments, the microcontroller (130) may be further configured to execute one or more machine learning algorithms configured to adaptively refine detection thresholds based on historical usage patterns. In some embodiments, the remote user interaction of the wireless communication interface (150) may comprise remote configuration of detection parameters and manual shutoff control.

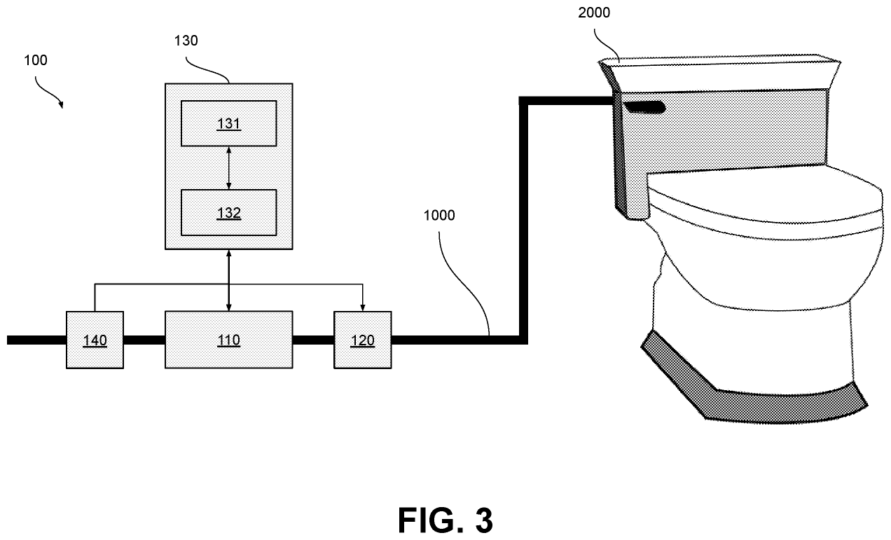

Referring now to FIG. 3 self-powered toilet monitoring system (100) for preventing water waste in a water supply line (1000) fluidly coupled to a toilet (2000). In some embodiments, the self-powered toilet monitoring system (100) may comprise a flow meter (111) disposed on the water supply line (1000), configured to measure a flow rate of a water flow. The self-powered toilet monitoring system (100) may further comprise a pressure sensor (112) disposed on the water supply line (1000), configured to measure a pressure measurement of the water flow. The self-powered toilet monitoring system (100) may further comprise a motorized shutoff valve (120) disposed on the water supply line (1000), configured to stop the water flow upon actuation. The self-powered toilet monitoring system (100) may further comprise a computing system (130) communicatively coupled to the flow meter (111), the pressure sensor (112), and the motorized shutoff valve (120).

The computing system (130) may comprise a processor (131) configured to execute computer-readable instructions. The computing system (130) may further comprise a memory component (132) operatively coupled to the processor (131), comprising computer-readable instructions. The computer-readable instructions may comprise receiving the flow rate from the flow meter (111) and the pressure measurement from the pressure sensor (112). The computer-readable instructions may further comprise analyzing the flow rate from the flow meter (111) and the pressure measurement from the pressure sensor (112) to detect anomalies. The anomalies may be determined based on whether or not the flow rate exceeds a flow rate threshold, the pressure measurement exceeds a pressure threshold, or a combination thereof. The anomalies may be indicative of continuous flow of the toilet (2000) caused by faulty fill valves, flappers, or a combination thereof, undetected leaks in a tank of the toilet (2000), the water supply line (1000), or a combination thereof, or a combination thereof. The computer-readable instructions may further comprise actuating, if anomalies are found, the motorized shutoff valve (120) to stop the water flow. The computer-readable instructions may further comprise sending, if anomalies are found, one or more alerts comprising information on the anomalies to an external user device communicatively coupled to the computing system (130). The computer-readable instructions may further comprise accepting one or more adjustments to the flow rate threshold, the pressure threshold, or a combination thereof from the external user device.

The self-powered toilet monitoring system (100) may further comprise an energy harvesting module (140) disposed on the water supply line (1000), operatively coupled to the flow meter (111), the pressure sensor (112), the motorized shutoff valve (120), the computing system (130), or a combination thereof, configured to generate power from the water flow such that the flow meter (111), the pressure sensor (112), the motorized shutoff valve (120), the computing system (130), or the combination thereof are powered by the energy harvesting module (140). In some embodiments, the energy harvesting module (140) may comprise a micro-turbine placed inline with the water flow, a piezoelectric system capturing energy from fluctuations in pressure in the water flow, or a combination thereof. In some embodiments, the memory component (132) may further comprise one or more machine learning algorithms configured to adaptively refine detection thresholds based on historical usage patterns.

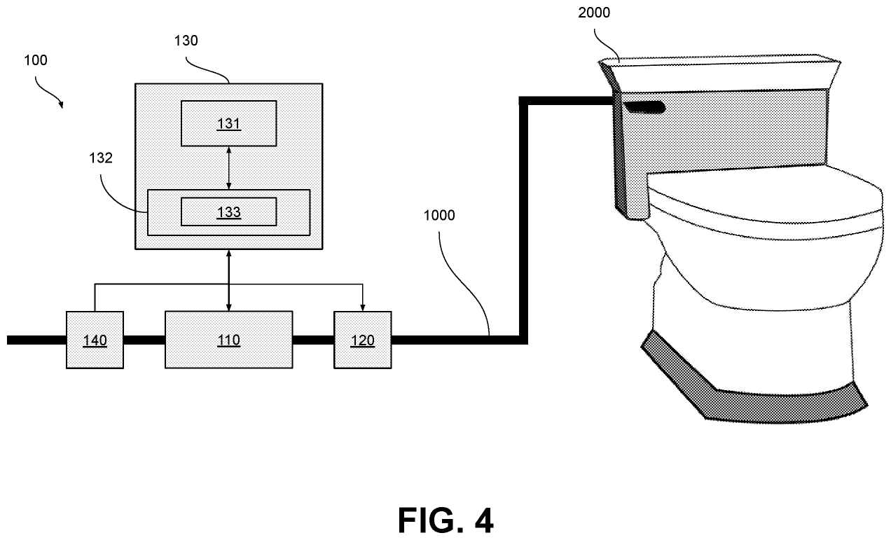

Referring now to FIG. 4, the present invention features a self-powered toilet monitoring system (100) for preventing water waste in a water supply line (1000) fluidly coupled to a toilet (2000). In some embodiments, the self-powered toilet monitoring system (100) may comprise a flow meter (111) disposed on the water supply line (1000), configured to measure a flow rate of a water flow. The self-powered toilet monitoring system (100) may further comprise a pressure sensor (112) disposed on the water supply line (1000), configured to measure a pressure measurement of the water flow. The self-powered toilet monitoring system (100) may further comprise a motorized shutoff valve (120) disposed on the water supply line (1000), configured to stop the water flow upon actuation.

The self-powered toilet monitoring system (100) may further comprise a computing system (130) communicatively coupled to the flow meter (111), the pressure sensor (112), and the motorized shutoff valve (120). The computing system (130) may comprise a processor (131) configured to execute computer-readable instructions. The computing system (130) may further comprise a memory component (132) operatively coupled to the processor (131). The memory component (132) may comprise a machine learning model (133) trained by historical data of flow rates, pressure measurements, or a combination thereof indicative of anomalies, configured to accept the flow rate and the pressure measurement as input and generate an adjustment to a flow rate threshold, a pressure threshold, or a combination thereof as output.

The memory component (132) may further comprise computer-readable instructions. The computer-readable instructions may comprise receiving the flow rate from the flow meter (111) and the pressure measurement from the pressure sensor (112). The computer-readable instructions may further comprise analyzing the flow rate from the flow meter (111) and the pressure measurement from the pressure sensor (112) to detect anomalies. The anomalies may be determined based on whether or not the flow rate exceeds the flow rate threshold, the pressure measurement exceeds the pressure threshold, or a combination thereof. The computer-readable instructions may further comprise actuating, if anomalies are found, the motorized shutoff valve (120) to stop the water flow. The computer-readable instructions may further comprise sending, if anomalies are found, one or more alerts comprising information on the anomalies to an external user device communicatively coupled to the computing system (130). The computer-readable instructions may further comprise accepting one or more adjustments to the flow rate threshold, the pressure threshold, or a combination thereof from the external user device. The computer-readable instructions may further comprise adjusting the flow rate threshold, the pressure threshold, or a combination thereof based on the output of the machine learning model.

The self-powered toilet monitoring system (100) may further comprise an energy harvesting module (140) disposed on the water supply line (1000), operatively coupled to the flow meter (111), the pressure sensor (112), the motorized shutoff valve (120), the computing system (130), or a combination thereof, configured to generate power from the water flow such that the flow meter (111), the pressure sensor (112), the motorized shutoff valve (120), the computing system (130), or the combination thereof are powered by the energy harvesting module (140). In some embodiments, the anomalies may comprise properties indicative of continuous flow of the toilet (2000) caused by faulty fill valves, flappers, or a combination thereof, undetected leaks in a tank of the toilet (2000), the water supply line (1000), or a combination thereof, or a combination thereof. In some embodiments, the energy harvesting module (140) may comprise a micro-turbine placed inline with the water flow, a piezoelectric system capturing energy from fluctuations in pressure in the water flow, or a combination thereof.

The present invention features a flow meter. In some embodiments, the flow meter may be configured to measure the water flow rate in gallons per minute (GPM) or liters per second (LPS). The sensor is precise enough to detect minimal changes in flow that indicate a leak. The present invention features a pressure sensor. The pressure sensor may be configured to measure water pressure within the supply line to identify pressure drops indicative of leaks or continuous water flow. It should be noted that some embodiments of the presently claimed invention may not require the implementation of a pressure sensor. The present invention features an energy harvesting unit. The energy harvesting unit may comprise a micro-turbine installed in the water flow path configured to convert kinetic energy into electrical energy. Alternatively, piezoelectric materials may generate energy from pressure fluctuations in the supply line. The present invention features a shutoff valve. The shutoff valve may comprise a solenoid or motorized ball valve, controlled by the system, configured to automatically close when anomalies are detected.

In some embodiments, the present invention features a computer system configured to execute an algorithm. In some embodiments, the algorithm may comprise detecting anomalies based on water usage patterns, flow rates, and pressure changes. For example, continuous low-flow conditions over a predefined time period could indicate a running toilet. The algorithm may further comprise calibrating based on known toilet flush rates. The algorithm may further comprise using historical data to adapt and refine detection thresholds. The computer system may comprise a low-power microcontroller configured to manage data from sensors, run algorithms, and activate the shutoff valve as needed.

In some embodiments, the present invention features mobile application integration. The mobile application may comprise functionality for alerting users of detected leaks or shutoff events, displaying historical water usage data and savings, or a combination thereof. The mobile application may further comprise functionality for users to override the shutoff valve or configure detection thresholds via the app. In some embodiments, the device of the present invention may be installed inline on the toilet's water supply line between the angle stop valve and the tank. The flow meter and energy harvesting module of the present invention may operate passively during normal water usage. Upon detecting anomalies, the system of the present invention may activate the shutoff valve and send an alert to the user.

In some embodiments, the microcontroller and/or the computing system of the present invention may be configured to analyze the raw output from the one or more water sensors and identify one or more anomalies indicative of continuous flow in the toilet (2000). In some embodiments, these anomalies may comprise a flow rate detected by a flow meter that falls below a given threshold or is present for an amount of time exceeding a time threshold such that water is flowing for longer than expected for normal usage of a toilet. These anomalies may further comprise a drop in pressure detected by the pressure sensor below a given pressure threshold.

In some embodiments, the system (100) of the present invention may comprise a wireless communication interface (150). This allows for a separate computing device to wirelessly connect to the system (100) (e.g., a smartphone, a personal computing device, etc.) in order to remotely interact with the system (100), allowing for remote configuration of detection parameters (e.g., adjusting flow rate detection thresholds, pressure thresholds, timing thresholds, etc.). This may also allow for manual shutoff control by sending a signal to the motorized shutoff valve (120).

In some embodiments, the energy harvesting component further comprises an energy storage component operatively coupled to the micro-turbine placed inline with the water flow, the piezoelectric system capturing energy from fluctuations in pressure in the water flow, or the combination thereof. The energy storage component may be configured to store excess power and transmit the excess power to the one or more water sensors (110), the motorized shutoff valve (120), the microcontroller (130), or the combination thereof.

The computer system can include a desktop computer, a workstation computer, a laptop computer, a netbook computer, a tablet, a handheld computer (including a smartphone), a server, a supercomputer, a wearable computer (including a SmartWatch™), or the like and can include digital electronic circuitry, firmware, hardware, memory, a computer storage medium, a computer program, a processor (including a programmed processor), an imaging apparatus, wired/wireless communication components, or the like. The computing system may include a desktop computer with a screen, a tower, and components to connect the two. The tower can store digital images, numerical data, text data, or any other kind of data in binary form, hexadecimal form, octal form, or any other data format in the memory component. The data/images can also be stored in a server communicatively coupled to the computer system. The images can also be divided into a matrix of pixels, known as a bitmap that indicates a color for each pixel along the horizontal axis and the vertical axis. The pixels can include a digital value of one or more bits, defined by the bit depth. Each pixel may comprise three values, each value corresponding to a major color component (red, green, and blue). A size of each pixel in data can range from 8 bits to 24 bits. The network or a direct connection interconnects the imaging apparatus and the computer system.

The term “processor” encompasses all kinds of apparatus, devices, and machines for processing data, including by way of example a programmable microprocessor, a microcontroller comprising a microprocessor and a memory component, an embedded processor, a digital signal processor, a media processor, a computer, a system on a chip, or multiple ones, or combinations, of the foregoing. The apparatus can include special-purpose logic circuitry, e.g., an FPGA (field programmable gate array) or an ASIC (application-specific integrated circuit). Logic circuitry may comprise multiplexers, registers, arithmetic logic units (ALUs), computer memory, look-up tables, flip-flops (FF), wires, input blocks, output blocks, read-only memory, randomly accessible memory, electronically-erasable programmable read-only memory, flash memory, discrete gate or transistor logic, discrete hardware components, or any combination thereof. The apparatus also can include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures. The processor may include one or more processors of any type, such as central processing units (CPUs), graphics processing units (GPUs), special-purpose signal or image processors, field-programmable gate arrays (FPGAs), tensor processing units (TPUs), and so forth.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and interconnected by a communication network.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer programs, i.e., one or more modules of computer program instructions, encoded on computer storage medium for execution by, or to control the operation of, a data processing apparatus.

A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or can be included in, one or more separate physical components or media (e.g., multiple CDs, drives, or other storage devices). The operations described in this specification can be implemented as operations performed by a data processing apparatus on data stored on one or more computer-readable storage devices or received from other sources.

Program code embodied on a computer readable medium may be transmitted using any appropriate medium, including but not limited to wireless, wireline, optical fiber cable, R.F, Bluetooth, storage media, computer buses, etc., or any suitable combination of the foregoing. Computer program code for carrying out operations for aspects of the present disclosure may be written in any combination of one or more programming languages, including an object oriented programming language such as Java, Smalltalk, C#, Ruby, or the like, conventional procedural programming languages, such as Pascal, FORTRAN, BASIC, or similar programming languages, programming languages that have both object-oriented and procedural aspects, such as the “C” programming language, C++, Python, or the like, conventional functional programming languages such as Scheme, Common Lisp, Elixir, or the like, conventional scripting programming languages such as PHP, Perl, Javascript, or the like, or conventional logic programming languages such as PROLOG, ASAP, Datalog, or the like.

The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks.

However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

Computers typically include known components, such as a processor, an operating system, system memory, memory storage devices, input-output controllers, input-output devices, and display devices. It will also be understood by those of ordinary skill in the relevant art that there are many possible configurations and components of a computer and may also include cache memory, a data backup unit, and many other devices. To provide for interaction with a user, embodiments of the subject matter described in this specification can be implemented on a computer having a display device, e.g., an LCD (liquid crystal display), LED (light emitting diode) display, or OLED (organic light emitting diode) display, for displaying information to the user.

Examples of input devices include a keyboard, cursor control devices (e.g., a mouse or a trackball), a microphone, a scanner, and so forth, wherein the user can provide input to the computer. Other kinds of devices can be used to provide for interaction with a user as well; for example, feedback provided to the user can be in any form of sensory feedback, e.g., visual feedback, auditory feedback, or tactile feedback; and input from the user can be received in any form, including acoustic, speech, or tactile input. Examples of output devices include a display device (e.g., a monitor or projector), speakers, a printer, a network card, and so forth. Display devices may include display devices that provide visual information, this information typically may be logically and/or physically organized as an array of pixels. In addition, a computer can interact with a user by sending documents to and receiving documents from a device that is used by the user; for example, by sending web pages to a web browser on a user's client device in response to requests received from the web browser.

An interface controller may also be included that may comprise any of a variety of known or future software programs for providing input and output interfaces. For example, interfaces may include what are generally referred to as “Graphical User Interfaces” (often referred to as GUI's) that provide one or more graphical representations to a user. Interfaces are typically enabled to accept user inputs using means of selection or input known to those of ordinary skill in the related art. In some implementations, the interface may be a touch screen that can be used to display information and receive input from a user. In the same or alternative embodiments, applications on a computer may employ an interface that includes what are referred to as “command line interfaces” (often referred to as CLI's). CLI's typically provide a text based interaction between an application and a user. Typically, command line interfaces present output and receive input as lines of text through display devices. For example, some implementations may include what are referred to as a “shell” such as Unix Shells known to those of ordinary skill in the related art, or Microsoft® Windows Powershell that employs object-oriented type programming architectures such as the Microsoft®.NET framework.

Those of ordinary skill in the related art will appreciate that interfaces may include one or more GUI's, CLI's or a combination thereof. A processor may include a commercially available processor such as a Celeron, Core, or Pentium processor made by Intel Corporation®, a SPARC processor made by Sun Microsystems®, an Athlon, Sempron, Phenom, or Opteron processor made by AMD Corporation®, or it may be one of other processors that are or will become available. Some embodiments of a processor may include what is referred to as multi-core processor and/or be enabled to employ parallel processing technology in a single or multi-core configuration. For example, a multi-core architecture typically comprises two or more processor “execution cores”. In the present example, each execution core may perform as an independent processor that enables parallel execution of multiple threads. In addition, those of ordinary skill in the related field will appreciate that a processor may be configured in what is generally referred to as 32 or 64 bit architectures, or other architectural configurations now known or that may be developed in the future.

A processor typically executes an operating system, which may be, for example, a Windows type operating system from the Microsoft Corporation®; the Mac OS X operating system from Apple Computer Corp.®; a Unix® or Linux®-type operating system available from many vendors or what is referred to as an open source; another or a future operating system; or some combination thereof. An operating system interfaces with firmware and hardware in a well-known manner, and facilitates the processor in coordinating and executing the functions of various computer programs that may be written in a variety of programming languages. An operating system, typically in cooperation with a processor, coordinates and executes functions of the other components of a computer. An operating system also provides scheduling, input-output control, file and data management, memory management, and communication control and related services, all in accordance with known techniques.

Connecting components may be properly termed as computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

The present invention may comprise or implement a neural network for machine learning tasks. The neural network may be stored, trained, and/or executed entirely on the user's computer, partly on the user's computer, as a stand-alone software package, partly on the user's computer and partly on a remote computer or entirely on the remote computer or server. The neural network may be stored in the form of program code, as described above.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting essentially of” or “consisting of”, and as such the written description requirement for claiming one or more embodiments of the present invention using the phrase “consisting essentially of” or “consisting of” is met.

Reference numbers recited herein, in the drawings, and in the claims are solely for ease of examination of this patent application and are exemplary. The reference numbers are not intended in any way to limit the scope of the claims to the particular features having the corresponding reference numbers in the drawings.

What is claimed is:

1) A self-powered toilet monitoring system (100) for preventing water waste in a water supply line (1000) fluidly coupled to a toilet (2000), the self-powered toilet monitoring system (100) comprising:
a) one or more water sensors (110) disposed on the water supply line (1000), configured to measure one or more properties of a water flow;
b) a motorized shutoff valve (120) disposed on the water supply line (1000), configured to stop the water flow upon actuation;
c) a microcontroller (130) communicatively coupled to the one or more water sensors (110) and the motorized shutoff valve (120), configured to analyze the one or more properties to detect anomalies and actuate the motorized shutoff valve (120) to stop the water flow in response to the anomalies; and
d) an energy harvesting module (140) disposed on the water supply line (1000), operatively coupled to the one or more water sensors (110), the motorized shutoff valve (120), the microcontroller (130), or a combination thereof, configured to generate power from the water flow such that the one or more water sensors (110), the motorized shutoff valve (120), the microcontroller (130), or the combination thereof are powered by the energy harvesting module (140).

2) The self-powered toilet monitoring system (100) of claim 1, wherein the one or more water sensors comprise a flow meter (111), a pressure sensor (112), or a combination thereof.

3) The self-powered toilet monitoring system (100) of claim 1, wherein the anomalies comprise properties indicative of continuous flow in the toilet (2000) caused by faulty fill valves, flappers, or a combination thereof, undetected leaks in a tank of the toilet (2000), the water supply line (1000), or a combination thereof, or a combination thereof.

4) The self-powered toilet monitoring system (100) of claim 1, wherein the energy harvesting module (140) comprises a micro-turbine placed inline with the water flow, a piezoelectric system capturing energy from fluctuations in pressure in the water flow, or a combination thereof, and an energy storage component operatively coupled to the micro-turbine placed inline with the water flow, the piezoelectric system capturing energy from fluctuations in pressure in the water flow, or the combination thereof, configured to store excess power and transmit the excess power to the one or more water sensors (110), the motorized shutoff valve (120), the microcontroller (130), or the combination thereof.

5) The self-powered toilet monitoring system (100) of claim 1, wherein the microcontroller (130) is further configured to execute one or more machine learning algorithms configured to adaptively refine detection thresholds based on historical usage patterns.

6) The self-powered toilet monitoring system (100) of claim 1 further comprising a wireless communication interface (150) communicatively coupled to the microcontroller (130), configured to send alerts and allow remote user interaction.

7) The self-powered toilet monitoring system (100) of claim 6, wherein the remote user interaction of the wireless communication interface (150) comprises remote configuration of detection parameters and manual shutoff control.

8) A self-powered toilet monitoring system (100) for preventing water waste in a water supply line (1000) fluidly coupled to a toilet (2000), the self-powered toilet monitoring system (100) comprising:
a) one or more water sensors (110) comprising:
i) a flow meter (111) disposed on the water supply line (1000), configured to measure a flow rate of a water flow; and
ii) a pressure sensor (112) disposed on the water supply line (1000), configured to measure a pressure measurement of the water flow;
b) a motorized shutoff valve (120) disposed on the water supply line (1000), configured to stop the water flow upon actuation;
c) a microcontroller (130) communicatively coupled to the flow meter (111), the pressure sensor (112), and the motorized shutoff valve (120), configured to analyze the flow rate from the flow meter (111) and the pressure measurement from the pressure sensor (112) to detect anomalies and actuate the motorized shutoff valve (120) to stop the water flow in response to the anomalies;
d) an energy harvesting module (140) disposed on the water supply line (1000), operatively coupled to the flow meter (111), the pressure sensor

(112) the motorized shutoff valve (120), the microcontroller (130), or a combination thereof, configured to generate power from the water flow such that the flow meter (111), the pressure sensor (112), the motorized shutoff valve (120), the microcontroller (130), or the combination thereof are powered by the energy harvesting module (140); and
e) a wireless communication interface (150) communicatively coupled to the microcontroller (130), configured to send alerts and allow remote user interaction.

9) The self-powered toilet monitoring system (100) of claim 8, wherein the anomalies comprise properties indicative of continuous flow of the toilet (2000) caused by faulty fill valves, flappers, or a combination thereof, undetected leaks in a tank of the toilet (2000), the water supply line (1000), or a combination thereof, or a combination thereof.

10) The self-powered toilet monitoring system (100) of claim 8, wherein the energy harvesting module (140) comprises a micro-turbine placed inline with the water flow, a piezoelectric system capturing energy from fluctuations in pressure in the water flow, or a combination thereof, and an energy storage component operatively coupled to the micro-turbine placed inline with the water flow, the piezoelectric system capturing energy from fluctuations in pressure in the water flow, or the combination thereof, configured to store excess power and transmit the excess power to the one or more water sensors (110), the motorized shutoff valve (120), the microcontroller (130), or the combination thereof.

11) The self-powered toilet monitoring system (100) of claim 8, wherein the microcontroller (130) is further configured to execute one or more machine learning algorithms configured to adaptively refine detection thresholds based on historical usage patterns.

12) The self-powered toilet monitoring system (100) of claim 8, wherein the remote user interaction of the wireless communication interface (150) comprises remote configuration of detection parameters and manual shutoff control.

13) A self-powered toilet monitoring system (100) for preventing water waste in a water supply line (1000) fluidly coupled to a toilet (2000), the self-powered toilet monitoring system (100) comprising:
a) one or more water sensors (110) comprising:
i) a flow meter (111) disposed on the water supply line (1000), configured to measure a flow rate of a water flow; and
ii) a pressure sensor (112) disposed on the water supply line (1000), configured to measure a pressure measurement of the water flow;
b) a motorized shutoff valve (120) disposed on the water supply line (1000), configured to stop the water flow upon actuation;
c) a computing system (130) communicatively coupled to the flow meter (111), the pressure sensor (112), and the motorized shutoff valve (120), the computing system (130) comprising:
i) a processor (131) configured to execute computer-readable instructions; and
ii) a memory component (132) operatively coupled to the processor (131), comprising computer-readable instructions for:
A) receiving the flow rate from the flow meter (111) and the pressure measurement from the pressure sensor (112);
B) analyzing the flow rate from the flow meter (111) and the pressure measurement from the pressure sensor (112) to detect anomalies, wherein the anomalies are determined based on whether or not the flow rate exceeds a flow rate threshold, the pressure measurement exceeds a pressure threshold, or a combination thereof;
wherein the anomalies are indicative of continuous flow of the toilet (2000) caused by faulty fill valves, flappers, or a combination thereof, undetected leaks in a tank of the toilet (2000), the water supply line (1000), or a combination thereof, or a combination thereof;
C) actuating, if anomalies are found, the motorized shutoff valve (120) to stop the water flow;
D) sending, if anomalies are found, one or more alerts comprising information on the anomalies to an external user device communicatively coupled to the computing system

(130) ; and
E) accepting one or more adjustments to the flow rate threshold, the pressure threshold, or a combination thereof from the external user device; and
d) an energy harvesting module (140) disposed on the water supply line (1000), operatively coupled to the flow meter (111), the pressure sensor (112), the motorized shutoff valve (120), the computing system (130), or a combination thereof, configured to generate power from the water flow such that the flow meter (111), the pressure sensor (112), the motorized shutoff valve (120), the computing system (130), or the combination thereof are powered by the energy harvesting module (140).

14) The self-powered toilet monitoring system (100) of claim 13, wherein the energy harvesting module (140) comprises a micro-turbine placed inline with the water flow, a piezoelectric system capturing energy from fluctuations in pressure in the water flow, or a combination thereof, and an energy storage component operatively coupled to the micro-turbine placed inline with the water flow, the piezoelectric system capturing energy from fluctuations in pressure in the water flow, or the combination thereof, configured to store excess power and transmit the excess power to the one or more water sensors (110), the motorized shutoff valve (120), the computing system (130), or the combination thereof.

15) The self-powered toilet monitoring system (100) of claim 13, wherein the memory component (132) further comprises one or more machine learning algorithms configured to adaptively refine detection thresholds based on historical usage patterns.

16) A self-powered toilet monitoring self-powered toilet monitoring system (100) for preventing water waste in a water supply line (1000) fluidly coupled to a toilet (2000), the self-powered toilet monitoring system (100) comprising:
a) one or more water sensors (110) comprising:
i) a flow meter (111) disposed on the water supply line (1000), configured to measure a flow rate of a water flow; and
ii) a pressure sensor (112) disposed on the water supply line (1000), configured to measure a pressure measurement of the water flow;
b) a motorized shutoff valve (120) disposed on the water supply line (1000), configured to stop the water flow upon actuation;
c) a computing system (130) communicatively coupled to the flow meter (111), the pressure sensor (112), and the motorized shutoff valve (120), the computing system (130) comprising:
i) a processor (131) configured to execute computer-readable instructions; and
ii) a memory component (132) operatively coupled to the processor (131), comprising:
A) a machine learning model (133) trained by historical data of flow rates, pressure measurements, or a combination thereof indicative of anomalies, configured to accept the flow rate and the pressure measurement as input and generate an adjustment to a flow rate threshold, a pressure threshold, or a combination thereof as output; and
B) computer-readable instructions for:
I) receiving the flow rate from the flow meter (111) and the pressure measurement from the pressure sensor (112);
II) analyzing the flow rate from the flow meter (111) and the pressure measurement from the pressure sensor (112) to detect anomalies, wherein the anomalies are determined based on whether or not the flow rate exceeds the flow rate threshold, the pressure measurement exceeds the pressure threshold, or a combination thereof;
III) actuating, if anomalies are found, the motorized shutoff valve (120) to stop the water flow;
IV) sending, if anomalies are found, one or more alerts comprising information on the anomalies to an external user device communicatively coupled to the computing system (130);
V) accepting one or more adjustments to the flow rate threshold, the pressure threshold, or a combination thereof from the external user device; and
VI) adjusting the flow rate threshold, the pressure threshold, or a combination thereof based on the output of the machine learning model; and
d) an energy harvesting module (140) disposed on the water supply line (1000), operatively coupled to the flow meter (111), the pressure sensor (112), the motorized shutoff valve (120), the computing system (130), or a combination thereof, configured to generate power from the water flow such that the flow meter (111), the pressure sensor (112), the motorized shutoff valve (120), the computing system (130), or the combination thereof are powered by the energy harvesting module (140).

17) The self-powered toilet monitoring system (100) of claim 16, wherein the anomalies comprise properties indicative of continuous flow of the toilet (2000) caused by faulty fill valves, flappers, or a combination thereof, undetected leaks in a tank of the toilet (2000), the water supply line (1000), or a combination thereof, or a combination thereof.

18) The self-powered toilet monitoring system (100) of claim 16, wherein the energy harvesting module (140) comprises a micro-turbine placed inline with the water flow, a piezoelectric system capturing energy from fluctuations in pressure in the water flow, or a combination thereof, and an energy storage component operatively coupled to the micro-turbine placed inline with the water flow, the piezoelectric system capturing energy from fluctuations in pressure in the water flow, or the combination thereof, configured to store excess power and transmit the excess power to the one or more water sensors (110), the motorized shutoff valve (120), the computing system (130), or the combination thereof.
